(19) United States
(12) Patent Application Publication
(10) Pub. No.: US 2013/0199114 A1
(43) Pub. Date: Aug. 8, 2013

(54) Door frame and threshold

(71) Applicant: Isaac Ben Ezra, West Bloomfield, MI (US)

(72) Inventor: Isaac Ben Ezra, West Bloomfield, MI (US)

(21) Appl. No.: 13/385,153

(22) Filed: Feb. 6, 2012

(51) Int. Cl. E06B 1/52; E05C 19/00

(52) U.S. Cl. 52/173.1; 52/204.2

(57) ABSTRACT

A door frame with and threshold for mounting optional latch strikes, lock strikes and blank covers in the same door frame. The door jamb includes cut-outs and a reinforcement with depressed center portions opposite the cut-outs for attaching matching strikes of optional latches and locks. The shapes of the cut-outs, reinforcement and matching strikes cooperate in a manner which allow the same door frame to be used with existing latches and locks. The improved threshold eliminates the failures of seals in vertical gap in current thresholds because of temperature changes and persons stepping on thresholds.

### FIELD OF THE INVENTION

This invention relates to door frames and more particularly to a door frame and a threshold for commercial buildings.

### BACKGROUND OF THE INVENTION

The construction industry is as old as human history. It is very rare that major improvements are made in construction practices. The present invention relates to major improvements in door frame construction. The current practice is to provide unique door frames and strikes for existing latches and locks. In most instances, the strikes are sold with the latches and locks. This practice is costly because manufacturers must invest in unique tools and distributors must stock large numbers of door frames to satisfy market needs. Another drawback is that thresholds of commercial door frames are difficult to seal. Current practices drive up the prices of door frames and cause delays in filling orders. This is because manufacturers and distributors are discouraged from maintaining large inventories. Manufacturers are also discouraged from adopting efficient manufacturing practices. Building occupants are discouraged from substituting latches and locks because of the expense of changing door frames.

Most commercial steel door frames conform to U.S. Department of Commerce Standards CS 242-62 and CS 211-57. A single door frame that meets Standards CS 242-62 and CS 211-57 and accommodates existing latches and locks would fill a market void. Cost would be further reduced if it could be shipped and stored disassembled and easily assembled at time of use with simple tools.

### SUMMARY OF THE INVENTION

The present invention is a major improvement in current practices. One benefit is that it reduces the investments in tools and costs of manufacturing commercial door frames. Another benefit is that it eliminates delays in filling orders. Another benefit is it allows owners to upgrade latches and locks in exiting door frames. Another benefit is that it can be assembled at time of use. Another benefit is that it includes a threshold which is easy to seal.

The invention resides in providing strike jambs and strikes which allow a variety of existing latches and locks to be used with the same door frame. Heretofore, strike jambs and strikes have not been related in a manner which allowed the same door frame to be used with existing latches and locks. In a first embodiment, the invention is a kit which can be easily assembled with simple tools. The kit is comprised of a hinge and a strike jamb for attaching a variety of latches and locks to a door frame, a header having end portions for mechanically attaching the header to upper end portions of the strike and hinge jambs a threshold below said hinge and strike jambs. In a second embodiment the door frame is supplied as a pre-assembled kit.

The foregoing features, benefits, objects and best mode of practicing the invention and additional benefits and objects will become apparent from the ensuing detailed description of a preferred embodiment and the subject matter in which exclusive property rights are claimed is set forth in the numbered claims which are appended to the detailed description of the preferred embodiment.

Further features and benefits will become apparent by reference to the drawings and ensuing detailed description of a preferred embodiment which discloses the best mode contemplated in carrying out the invention. The exclusive rights which are claimed are set forth in each of the numbered claims following the detailed description of the preferred embodiment.

### BRIEF DESCRIPTION OF THE DRAWINGS

The invention will be better understood and further objects, characterizing features, details and advantages thereof will appear more clearly with reference to the diagrammatic drawings illustrating a specific embodiment of the invention by way of non-limiting example only.

FIG. 1 is a front view of a metal door frame and threshold.

FIG. 2 is a cross-sectional view taken on the line 2-2 in FIG. 1.

FIG. 3 is a cross-sectional view taken on the line 2-2 in FIG. 1.

FIG. 4 is an enlarged partial view of a strike jamb taken in the direction of arrow A in FIG. 1.

FIG. 5 is a cross-sectional view taken on the line 5-5 in FIG. 4.

FIG. 6 is an enlarged partial view of a hinge jamb taken in the direction of arrow B in FIG. 1.

FIG. 7 is a cross-sectional view taken on the line 7-7 in FIG. 4.

FIG. 8 is a fragmentary view of the strike jamb with a latch strike, lock strike and blank cover.

FIG. 9 is a cross-sectional view taken on the line 9-9 in FIG. 8.

FIG. 10 is a front view of the latch strike shown in FIG. 8.

FIG. 11 is a cross-sectional view taken on the line 11-11 in FIG. 10.

FIG. 12 is a front view of the blank cover shown in FIG. 8.

FIG. 13 is a left side view of the blank cover.

FIG. 14 is a front view of the lock strike shown in FIG. 8.

FIG. 15 is a left side view of the lock strike.

FIG. 16 is an enlarged upper fragmentary portion of FIG. 9.

FIG. 17 is an enlarged lower fragmentary portion of FIG. 9.

FIG. 18 is a fragmentary view of the strike jamb with a mortise lock strike and a blank cover.

FIG. 19 is a cross-sectional view taken on the line 19-19 in FIG. 18.

FIG. 20 is a front view of the mortise lock strike.

FIG. 21 is a left side view of the mortise lock strike.

FIG. 22 is an enlarged lower fragmentary portion of FIG. 19.

FIG. 23 is fragmentary portion of the strike jamb with a blank cover and latch strike.

FIG. 24 is a cross-sectional view taken on the line 24-24 in FIG. 23.

FIG. 25 is an enlarged upper fragmentary portion of FIG. 23.

FIG. 26 is a front view of the blank cover shown in FIG. 23.

FIG. 27 is a left side view of the blank cover.

FIG. 28 is a front view of the latch strike shown in FIG. 23.

FIG. 29 is a left side view of the latch strike.

FIG. 30 is a fragmentary portion of the strike jamb with an adjustable latch strike and a blank cover.

FIG. 31 is a cross-sectional view taken on the line 31-31 in FIG. 30.

FIG. 32 is an enlarged lower fragmentary portion of FIG. 50.

FIG. 52 is a front view of the adjustable latch strike shown in FIG. 31.

FIG. 34 is a front view of an adapter plate for the adjustable latch strike.

FIG. 35 is a bottom view of the adjustable latch strike.

FIG. 36 is a bottom view of the adapter platy for the adjustable latch strike.

FIG. 37 is a fragmentary portion of a plan view of a current threshhold.

FIG. 38 is a cross-sectional view taken on the line 38-38 in FIG. 37.

FIG. 39 is a fragmentary side view of the current threshold and a Jamb.

FIG. 40 is a fragmentary a plan view of an improved threshhold.

FIG. 41 is a cross-sectional view taken on the line 41-41 in FIG. 40.

FIG. 42 is a fragmentary side view of the improved threshold and lock jamb.

### DETAILED DESCRIPTION OF A PREFERRED EMBODIMENT

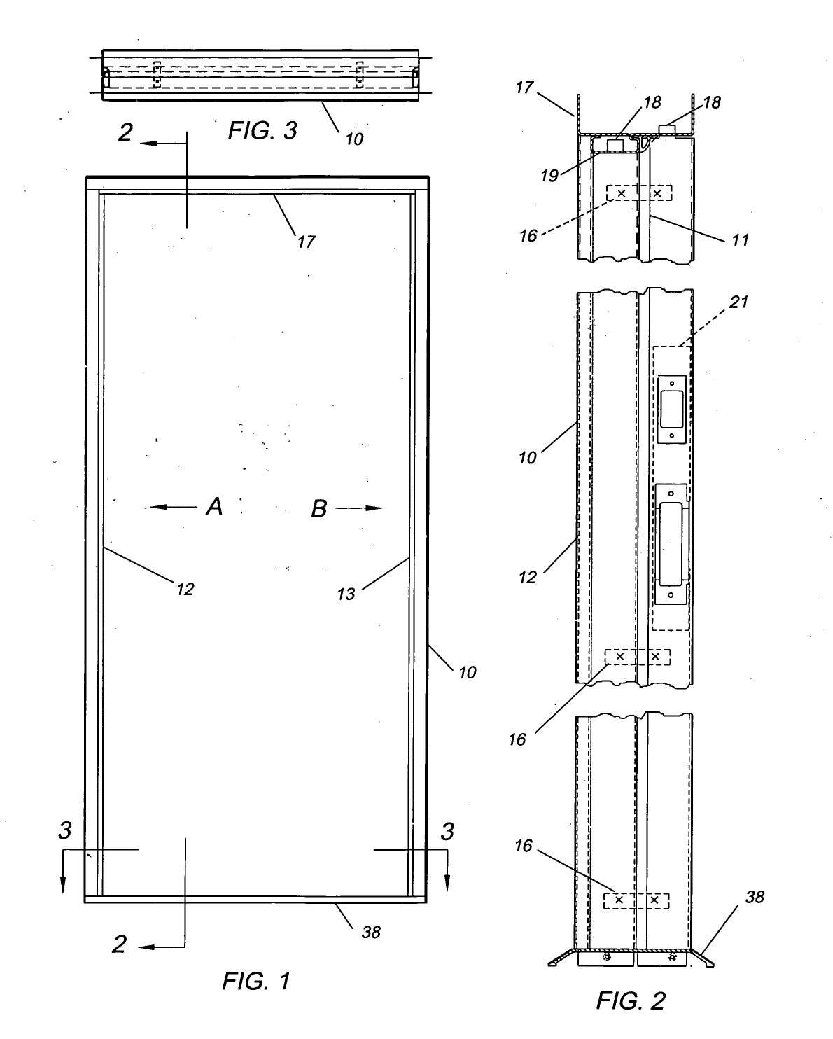

Referring now to the drawings wherein like numerals designate like and corresponding parts throughout the several views, a commercial steel entry door frame 10 is shown in FIG. 1. A principal feature of the door frame 10 is that a single design can be used with existing latches, deadbolt and mortise locks. Another feature is that it includes an improved threshold seal.

In a preferred embodiment the door frame 10 is supplied to a user as a kit comprised of separate members which can be assembled with simple tools. The kit is comprised of a strike 12 and a hinge jamb 13, a header 17, a seal 11, a threshold 35, a latch jamb 12 and/or a lock 40 strike and a plurality of strikes for existing latches and locks. The invention resides in providing a door frame which can accommodate strikes that will accept existing latches and locks. Heretofore, unique door frames have been provided for differences in latches and locks.

With reference to FIGS. 21 through 25, the header 17, strike jamb 12 and hinge jamb 13 are channel members consisting of a pair of longitudinal half members 14, 15 joined together by welded cross ties 16. The header 17 is attached to upper end portions of the strike 12 and hinge 13 jambs with tabs 18 on the jambs 12, 13 that engage the header 17 and thereafter bent. The half members 14, 15 have raised rectangular shaped portions 19 that serve as a door stop. At one side of the door stop 19 is a channel 20 which retains a portion of the seal 11.

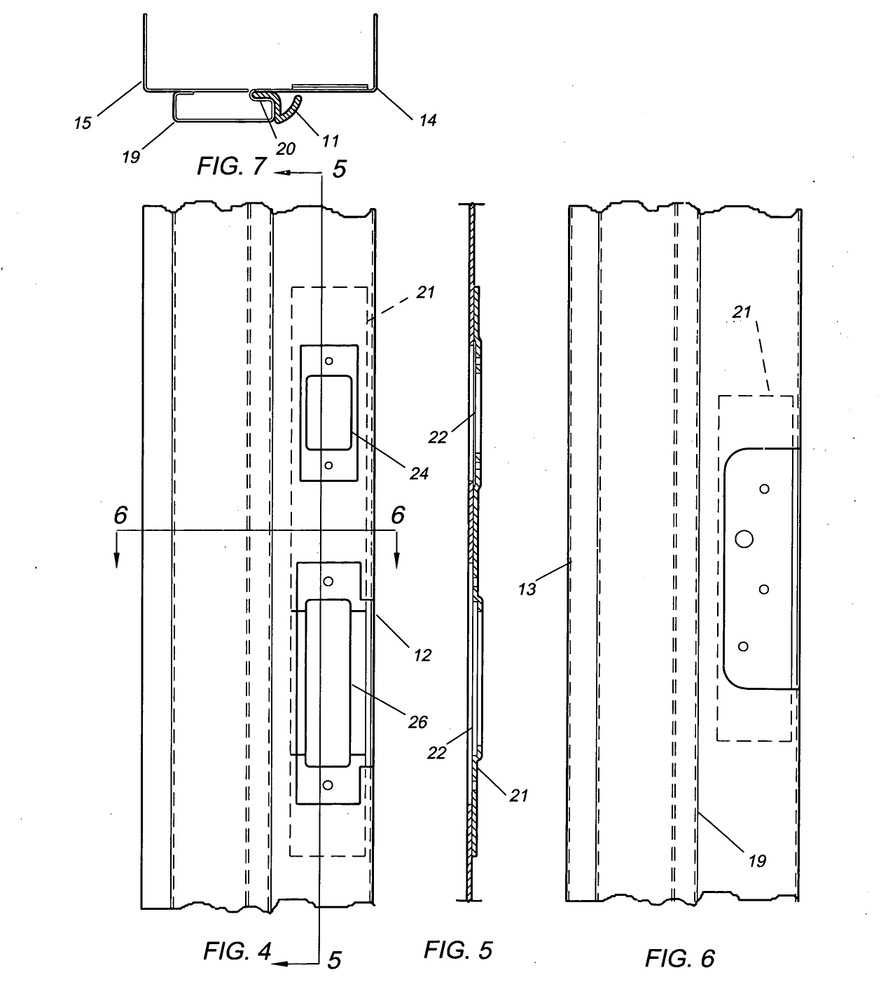

In FIGS. 4 through 7, the strike jamb 12 is shown without strikes. In the strike jamb 12, the reinforcement 21 is shown with tapped holes opposite upper 24 and lower 26 cut-outs for mounting strikes. In the reinforcement are depressions 22 whereby the upper surfaces of strikes will be flush with the outer surface of the jamb 12.

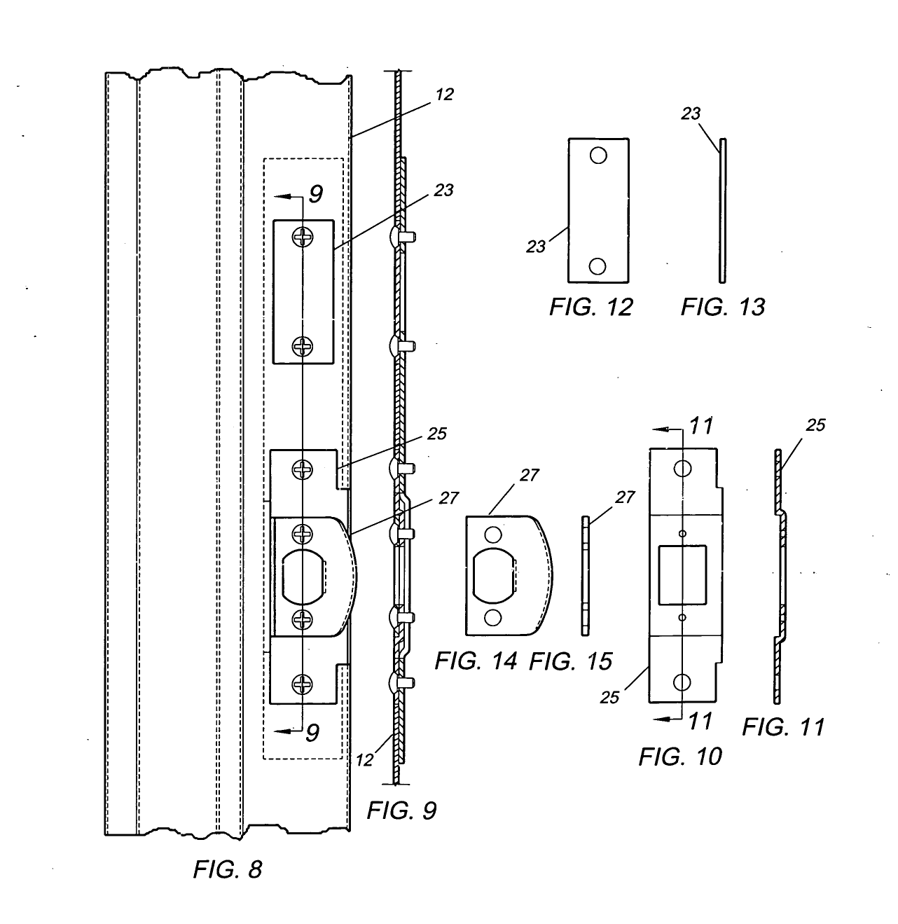

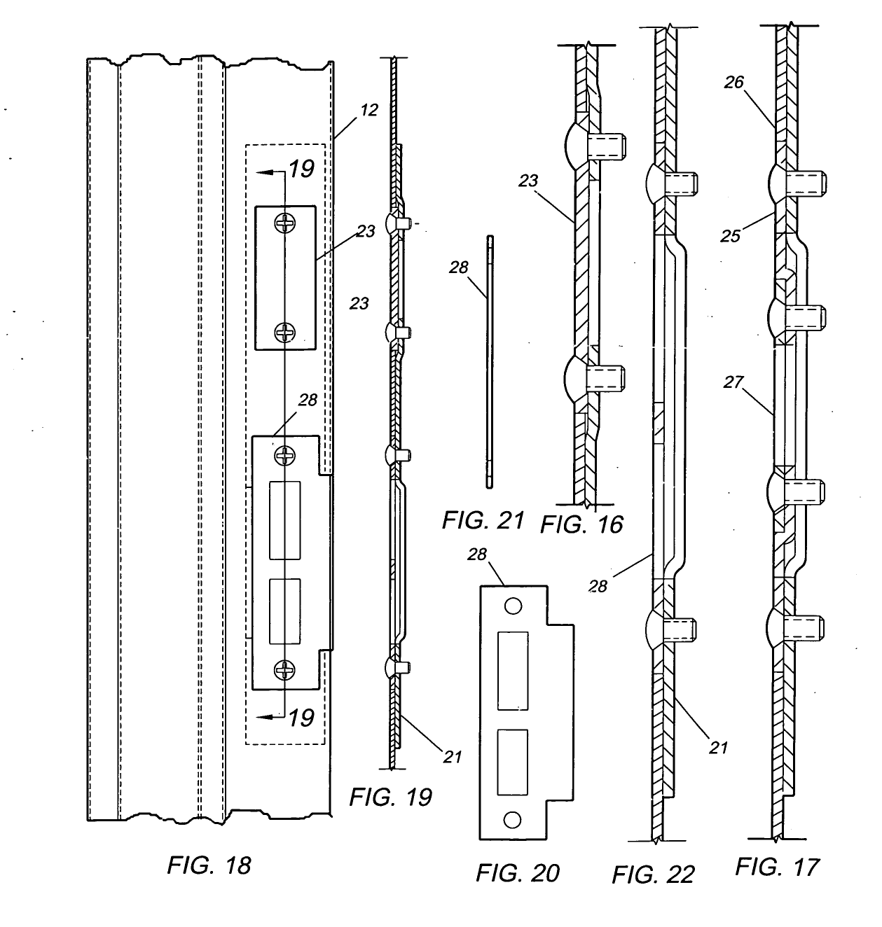

In FIGS. 8 through 17, a blank cover 23 is shown mounted opposite the upper cut-out 24 and a latch strike 25 is shown mounted opposite the lower cut-out 26. Above the latch strike 25 a deadbolt lock strike 27 is shown attached to the latch strike 25.

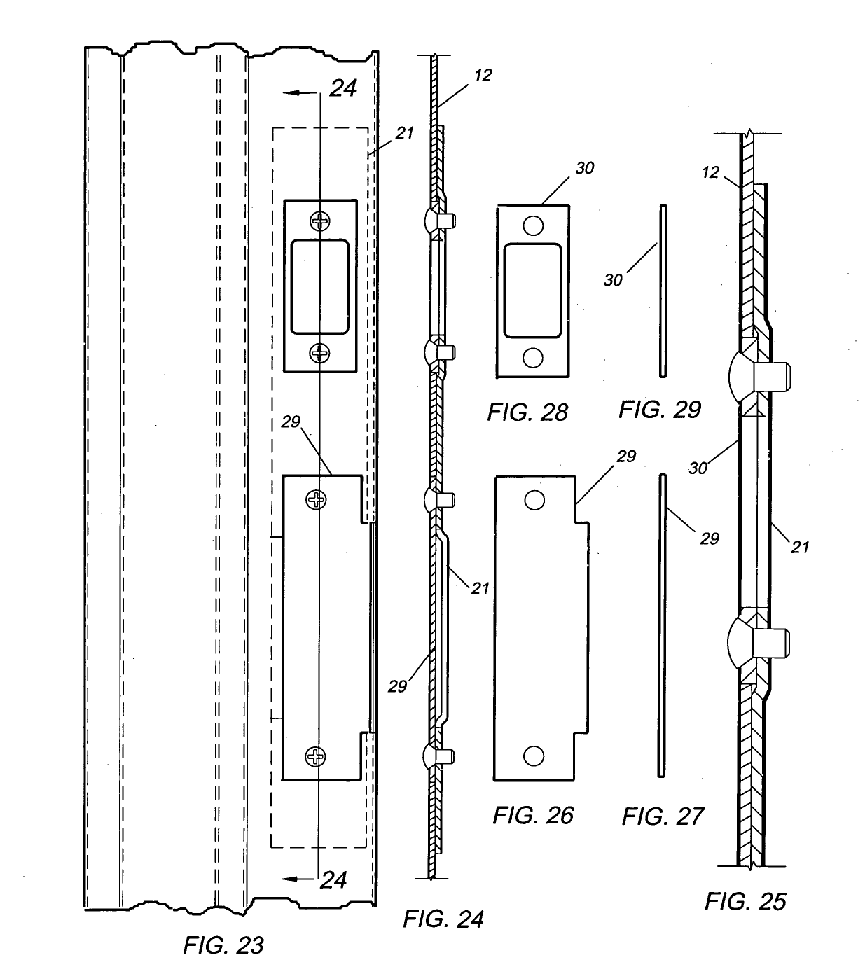

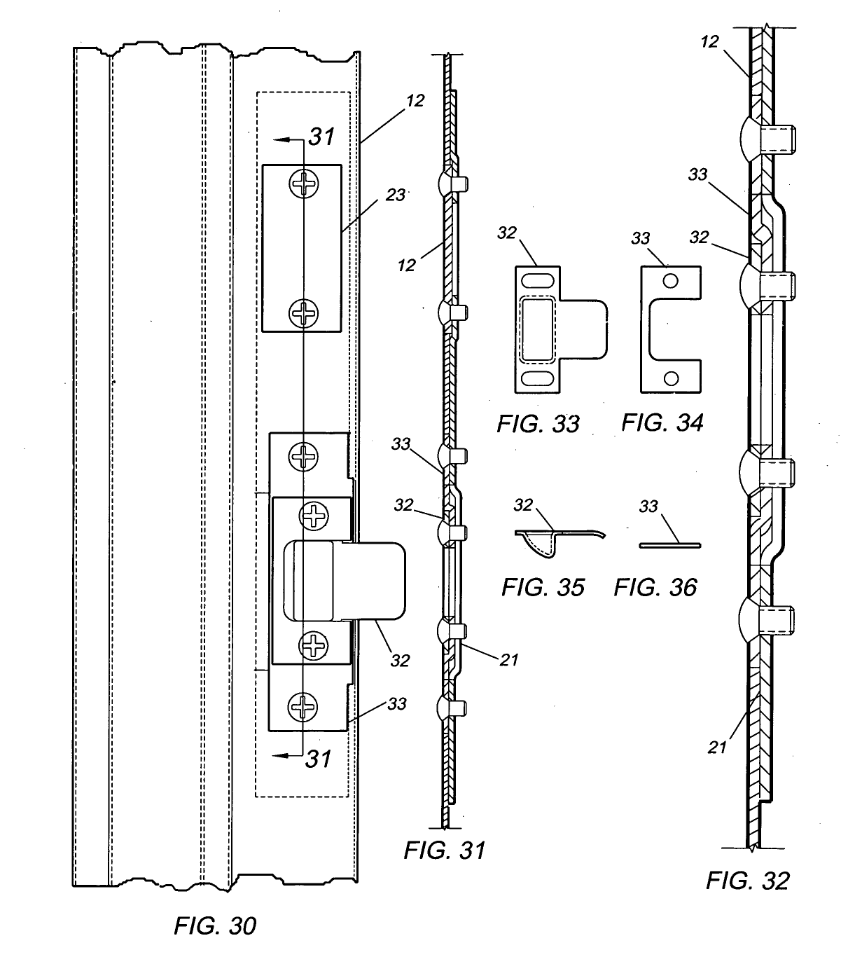

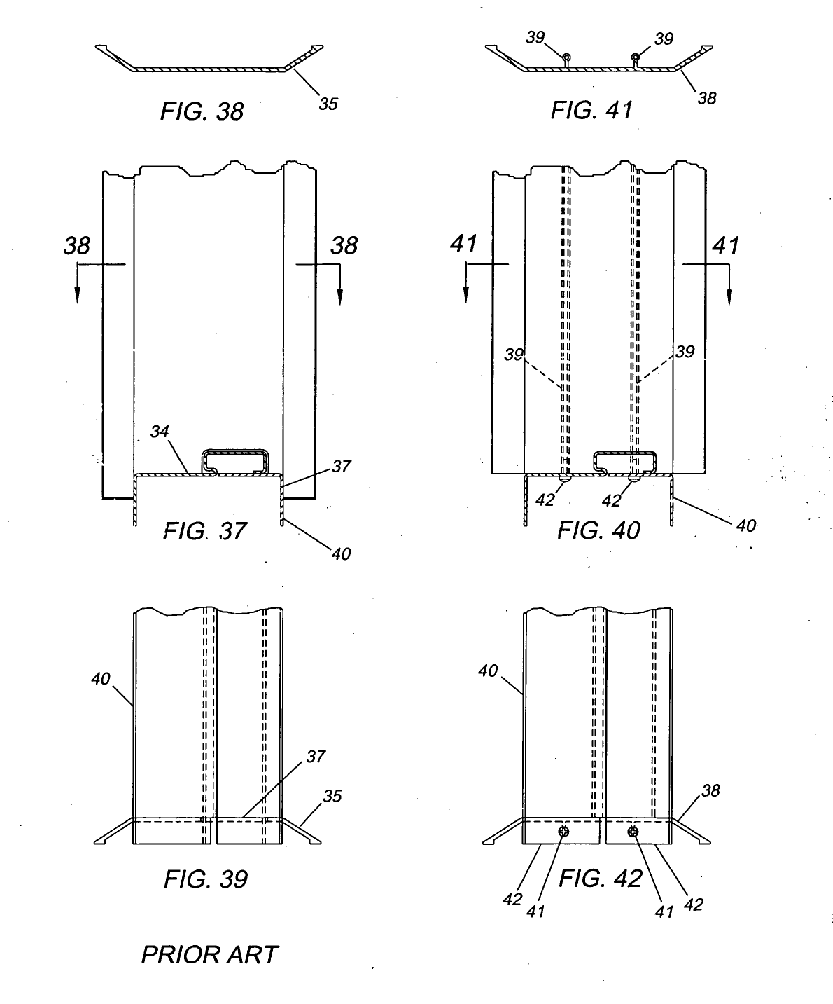

In FIGS. 18 through 22, the latch 25 and deadbolt lock 27 strikes have been replaced with a mortise lock strike 28. In FIGS. 23 through 29, the mortise lock strike 28 has been replaced with a blank cover 29 and the blank cover 23 opposite the upper cut-out 24 has been replaced with a latch strike 30. In FIGS. 30 through 36, the latch strike 30 has been replaced with the blank cover 23 and the blank cover 29 opposite the lower cut-out 26 has been replaced with an adjustable latch strike 32 mounted to an adapter plate 33.

The improved threshold 38 is shown compared to the current practice in FIGS. 37 through 42. In the current practice, a threshold 35 is positioned between lower end portions of a strike 36 and a hinge jamb (not shown). The ends of the threshold 35 have cut-outs 34 to locate the threshold 35 in a fore and aft direction. Thus, the threshold 35 is not positively attached to the jambs 36 and there is no way of fixing the size of the vertical gap 37 between the threshold 35 and jambs 36. Although the gap 37 can be filled with a sealer to prevent water from passing through the gap 37, the sealer is ineffective because the size of the gap 37 will vary due to temperature changes and loads from people stepping on the threshold 35. Attempts to solve this problem have been made but as yet none have been successful.

A solution to this problem is shown in FIGS. 41 though 42. In this design, strike 40 and hinge (not shown) jambs are supported above end portions of a threshold 38. Thus, the vertical gap 37 of the current practice is replaced with a horizontal gap. The threshold 38 is an extruded or cast member with ribs 39 extending along the length of the threshold 38 (or bosses at the ends of the threshold—not shown). Portions of the jambs 40 extend below the top of the threshold 38 and are attached to the threshold 38 with threaded fasteners 42. Thus, the cut outs in the threshold have been eliminated, the vertical gap 37 between the jambs 40 and threshold 38 has been eliminated and the threshold 38 has been fastened securely to the jambs 40.

From the above it is apparent that this invention provides important benefits over the current practice. A single door frame has been disclosed which eliminates the multiplicity of door frames to satisfy customer needs. The new door frame provides significant economic benefits to manufactures and builders by reducing complexity, investment and inventory costs and benefits customers be eliminating delays in filling orders. The door frame includes an improved threshold which provides a water tight seal between the threshold and jambs of the door frame.

Although only a single embodiment of my invention has been disclosed, it is obvious that additional embodiments may be provided by changes, such as changes in shape, materials, arrangement of parts known to persons skilled in art without departing from the spirit thereof.

What I claim is new is:

1. In combination, a door frame comprised of: a channel shaped hinge jamb for attaching hinges to mount said door frame to a building, said hinge jamb comprised of a pair of members joined together with welded cross ties, upper and lower cut-outs for locating door hinges, an integral rectangular shaped door stop portion, upper extending portions for attaching said hinge jamb to a header, a reinforcement opposite said cut-outs with threaded apertures and depressed portions for attaching hinges to, said hinge jamb, and downward extending portions for attaching said a threshold to said hinge jamb; a channel shaped strike jamb for attaching strikes and/or blank covers to said strike jamb; said strike jamb comprised of a pair of members joined together with welded cross ties, at least one cut-out for locating latch strikes; a reinforcement opposite said cut-outs with threaded apertures and depressed portions for attaching said strikes to said strike jamb, upper extending tab portions for attaching said strike jamb to a header, downward extending portions for attaching said strike jamb to a threshold; a channel shaped header attached to upper end portions of said hinge jamb and said strike jamb; a threshold attached to lower end portions of said hinge jamb and said strike jamb; and a plurality of latch and lock strikes for existing latches and locks.

2. The door frame recited in claim 1 wherein said strike jamb has a pair of cut-outs and said reinforcement has a pair of depressions for mounting strikes and/or blank covers.

3. The door frame recited in claim 2 further comprising a latch strike attached to said reinforcement opposite one of said cut-outs.

4. The door frame recited in claim 2 further comprising a lock strike attached to said reinforcement opposite one of said cut-outs.

5. The door frame recited in claim 2 further comprising a lock strike for a deadbolt lock attached to said reinforcement opposite one of said cut-outs.

6. The door frame recited in claim 2 further comprising a lock strike for a mortise lock attached to said reinforcement opposite one of said cut-outs.

7. The door frame recited in claim 2 further comprising an adjustable 2-piece latch strike attached to said reinforcement opposite one of said cut-outs, said adjustable 2-piece adjustable latch strike comprised of an adapter plate and a latch strike.

8. The door frame recited in claim 7 further comprising a blank cover attached to said reinforcement opposite another of said cut-outs.

9. The door frame recited in claim 1 wherein said lower end portions are threadably attached to end portions of said threshold.

10. A kit for assembling a door frame which is capable of mounting a variety of optional latches and locks, said kit comprised of: a channel shaped hinge jamb, said hinge jamb having upper extending tab portions for attaching upper end portions of said hinge jamb to a header and downward extending portions for attaching lower end portions of said hinge jamb to a threshold; a strike jamb, said strike jamb having upper extending portions for attaching upper end portions of said strike jamb to said header and downward extending portions for attaching lower end portions of said strike jamb to said threshold; a header for mechanically connecting said upper end tab portions of said hinge jamb to said upper end portions of said strike jamb; a threshold, said threshold having opposite end portions for threadably attaching said lower end portions of said hinge jamb with said lower end portions of said strike jamb; and a plurality of strikes for existing latches and locks.

11. In combination, a door frame for attaching optional strikes for use with existing latches and locks and a common door frame, said door frame comprising; a strike jamb having an upper and a lower cut-out for locating a variety of latch strikes or lock strikes and/or blank covers, a reinforcement on an opposite side of said jamb opposite said cut-outs, said reinforcements having a pair of threaded apertures and a depressed center portion for mounting said latch strikes or said lock strikes and/or said blank covers to said strike jamb; and a plurality of strikes for existing latches and locks.

12. The combination recited in claim 11 wherein said existing latches and locks are comprised of latch, deadbolt lock and mortise lock.
